(19) United States
(12) Patent Application Publication
(10) Pub. No.: US 2007/0070489 A1
(43) Pub. Date: Mar. 29, 2007

(54) Display device with suspended anisometric particles

(76) Inventors: Nynke A.M. Verhaegh, Eindhoven (NL); Dirk K.G. De Boer, Den Bosch (NL); Mark T. Johnson, Veldhoven (NL); Bas Van Der Heijden, Hoogeloon (NL)

Correspondence Address: PHILIPS INTELLECTUAL PROPERTY & STANDARDS, P.O. BOX 3001, BRIARCLIFF MANOR, NY, 10510, US

(21) Appl. No.: 10/572,838

(22) PCT Filed: Sep. 9, 2004
(86) PCT No.: PCT/IB04/51731

§ 371 Date: Nov. 1, 2006

(30) Foreign Application Priority Data
Sep. 23, 2003 (GB) 0322230.4

(51) Int. Cl. G02F 1/15

(52) U.S. Cl. 359/265

(57) ABSTRACT

A suspended particle device (SPD) 4 comprises at least one compartment for housing a particle suspension 1Oa, 1Ob, means for applying a first electric field to the particle suspension IOa, 1 Ob and means for applying a second electric field to the particle suspension 10a, 10b, the first and second electric fields having different field directions. A plurality of pixels are defined by a plurality of compartments, each housing a separate particle suspension 10a, 10b and/or regions of a particle suspension 10 within a compartment in which means for applying an inhomogeneous second electric field are provided (FIG. 11). Each pixel may be tuned to a transmissive state, a reflective state or an intermediate state or “grey value”, so that the SPD 4 may be used to display imaging or text. The SPD 4 may be reset by bringing the pixels into the same state by applying an appropriate electric field to one or more pixels.

The invention relates to an electro-optical cell in the form of a suspended particle device.

Suspended particle devices (SPDs) are used as light shutters or light valves in applications requiring control of light and/or heat energy transmission. For example, SPDs have been used in display devices, in windows and roofs of buildings and in satellites, in order to provide protection against sudden increases in light levels, and also as shutters in photographic equipment

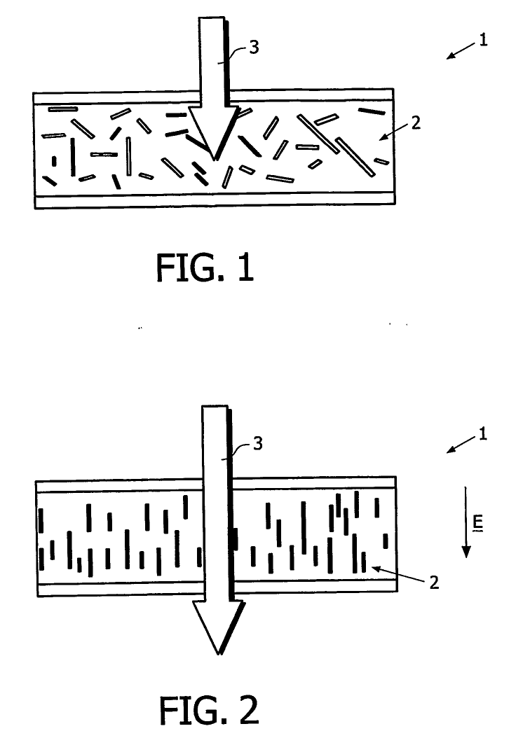

The operation of such a light valve will now be described with reference to FIGS. 1 and 2. A suspended particle device 1 comprises a number of anisometric inorganic particles in a suspension fluid, hereafter referred to as particle suspension 2. In the absence of external intervention, the particle alignment is disordered. That is, the particles have random orientations that vary over time due to Brownian motion. Therefore, light 3 incident on the light valve is obstructed, due to scattering and/or reflection by the particles, as shown in FIG. 1.

The alignments of the particles can be controlled by applying an electric field to the particle suspension, as shown in FIG. 2. The electric field induces a dipole in the particles. In order to minimise the energy of the system, the particles align themselves in a direction parallel to the electric field lines. The time required for the particles to align themselves following the application of an electric field is hereafter referred to as the response time.

In the example of FIG. 2, this substantially uniform re-alignment increases the transmittance of the particle suspension 2, so that an increased fraction of incident light 3 is transmitted. The electric field is equal to, or greater than, a saturation potential of the particle suspension 2, which is defined as the minimum voltage necessary to cause the particles within a particle suspension to become fully aligned with the electric field, so that the transmittance of the particle suspension 2 is maximised.

When the electric field is removed, the particles gradually return to the disordered state shown in FIG. 1, through Brownian motion, thereby closing the light valve. The time period required for the ordered particle alignment and, in this example, the transmittance of the particle suspension, to decay significantly is hereafter referred to as the relaxation time.

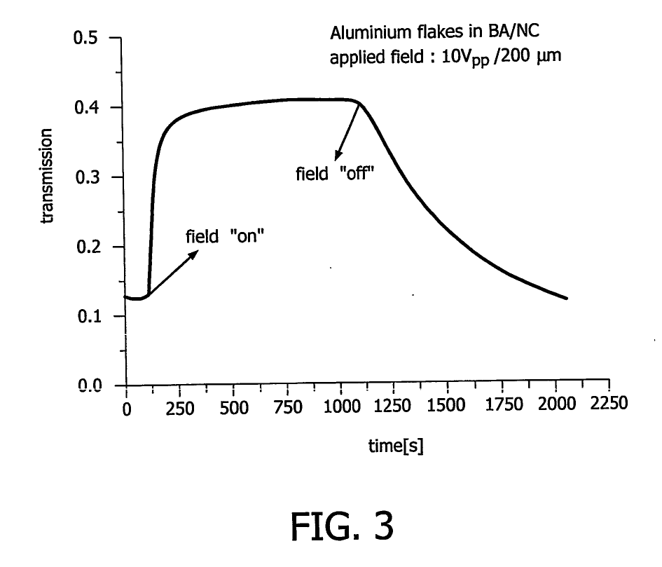

There are disadvantages associated with SPDs that limit their suitability for certain applications. For instance, the relaxation time may be too large for applications requiring rapid changes in optical properties. FIG. 3 is a graph of experimental data showing the response and relaxation time of a suspension of aluminium platelets. At time t=100 s, an electric field is applied as shown in FIG. 2, causing the particle suspension to become transmissive. The graph shows that the re-alignment of particles in response to the applied voltage is substantially complete within a time of approximately 60 s. At time t=1100 s, the electric field is removed. The graph shows that the transmittance decays to approximately 25% of its maximum value after a time period of approximately 1000 s has elapsed. However, the precise response time and relaxation time in a particular SPD will depend on the properties of the particles and suspension fluid, the voltages applied, the volume of the particle suspension and driving scheme used, where the driving scheme defines the voltages applied to the particle suspension as a function of time.

Another drawback relates to the settling of particles when the SPD is in use. Any agglomeration of the particles within the SPD tends to remain, even when an electric field is removed. This creates an inhomogeneity in the particle suspension 2 and may also reduce the optical density of the particle suspension 2 when the light valve is closed. Therefore, the uniformity of the optical properties of the light valve is adversely affected.

A SPD that overcomes these problems is disclosed in U.S. Pat. No. 3,708,219. This prior SPD comprises means for circulating the particle suspension within the light valve. By causing the particle suspension 2 to flow, agglomeration and settling are reduced. In one embodiment, the fluid circulates through two cells, with flow directions that were perpendicular to one another. Each cell would act as a polariser during closing of the cell, decreasing the apparent relaxation time. However, these arrangements require the inclusion of a pump, together with inlets and outlets to the light valve, resulting in a complicated SPD that is too bulky for use in certain devices.

According to a first aspect of the invention, a suspended particle device comprises at least one compartment for housing a particle suspension, means for applying a first electric field to the particle suspension configured so that the first electric field has a first orientation, and means for applying a second electric field to the particle suspension configured so that the second electric field has a second orientation that is different from said first orientation.

This aspect also provides a transflector formed by the SPD and a transflective display comprising such a transflector.

The SPD is configured so that particle alignment can be controlled using two or more electric fields, each with different field directions. This allows the optical properties of the particle suspension to be changed rapidly by altering the orientation of the electric field within the compartment, as the time required for a particle suspension to respond to an electric field is generally much shorter than the time required for the optical properties of the particle suspension to decay through Brownian motion of the particles. For example, where the suspended particle device is in a transmissive state, following the application of the first electric field, the SPD can be “closed” rapidly by applying the second electric field. Thus, the effective relaxation time of the device may be shortened, and the effects of agglomeration reduced.

Preferably, the first and second orientations are mutually perpendicular.

The SPD may comprise a plurality of spacers for defining a plurality of compartments. The compartments may then house a plurality of separate particle suspensions. As each particle suspension is restricted to a limited volume, any inhomogeniety caused by settling of particles is restricted to that compartment and does not affect the optical properties of the rest of the SPD. The means for applying the second electric field in such a SPD may be provided by the spacers, within the spacers or on the spacers.

The SPD may be arranged so that an inhomogeneous field may be applied to a particle suspension. For example, a particle suspension may be housed in a compartment where a plurality of means for applying an electric field with the first and/or second field direction are provided. A compartment may contain a plurality of regions, where each region is controlled using separate means for applying an electric field with said field direction. Where this is the case, the SPD may comprise one or more compartments that may be subjected to an inhomogeneous electric field.

A SPD comprising one or both of a plurality of separate particle suspensions or a plurality of regions within a compartment may be considered to comprise a plurality of pixels defined by its compartments and/or regions. The term “pixel” is used hereafter to indicate a particle suspension within a compartment or a particle suspension within a region of a compartment as described above.

A SPD comprising a plurality of pixels may be arranged so that one or more of the electric fields can be applied to one of the pixels independently of at least one other pixel. This allows the optical properties of one or more of the pixels to be tuned independently of at least one other pixel and can be used, for example, to display an image on the SPD. Such a SPD may further comprise an active matrix for addressing the pixels.

The means for applying the first and second electric fields including, where provided, the active matrix, may be configured to tune transmittance and reflectance properties of a pixel to an intermediate, or grey, value. For example, a grey value can be achieved by applying one or more electric fields to a pixel, where the applied voltage is less than the saturation potential of the particle suspension therein. Another method of tuning a pixel to a grey value comprises applying to one or more pixels first and second electric fields in the form of a series of pulses according to a suitable driving scheme.

The electric fields may be AC or DC and may be homogeneous or inhomogeneous.

According to a second aspect of the invention, a suspended particle device comprises a transparent plate, a substrate and a plurality of spacers, wherein said plate, substrate and spacers define a plurality of pixels. One or more of the pixels may be closed compartments defined by the transparent plate, substrate and spacers, the compartments being arranged to house a particle suspension.

Alternatively, or additionally, one or more of the pixels may be defined by regions within a compartment arranged to house a particle suspension, the SPD comprising means for simultaneously applying a first electric field with a given field direction to a first region and a second electric field with the same field direction to at least one other region. This permits the application of an inhomogeneous electric field to a particle suspension.

Within the SPD, each particle suspension is restricted to its compartment. Therefore, any inhomogeniety caused by settling of particles is also restricted to that compartment and cannot affect the optical properties of the rest of the SPD.

Preferably, the plurality of spacers comprise means for applying an electric field to the pixel. These means can be provided within a spacer or on a spacer, or constituted by a spacer.

The SPD may further be arranged so that one or more electric fields can be applied to a selected pixel independently of at least one other pixel. This allows optical properties such as reflectance and transmittance to vary between pixels and can be used to display an image on the SPD.

Such a SPD may further comprise an active matrix for addressing the compartments.

Any means for applying electric fields to the pixels including, where provided, the active matrix, may be configured to tune transmittance and reflectance properties of a pixel to an intermediate, or grey, value. For example, a grey value can be achieved by applying two or more electric fields with different field directions to one or more pixels in the form of a series of pulses according to a given driving scheme. Additionally, or alternatively, a grey value may also be achieved by applying one or more voltages to the pixels that are less than the saturation potential of the particle suspension.

The electric fields may be AC or DC and may be homogeneous or inhomogeneous.

This aspect also provides a transflector comprising the SPD and a transflective display including such a transflector.

According to a third aspect of the invention, a method of operating a suspended particle device including a particle suspension comprises the steps of applying to the particle suspension a first electric field with a first orientation to control alignment of particles therein and resetting the suspended particle device by applying to the particle suspension a second electric field with a second orientation that is different to the first orientation.

The SPD may comprise a plurality of pixels, defined by compartments housing separate particle suspensions and/or regions of a particle suspension that can be subjected to an inhomogeneous electric field, that is, where at least two of the regions can be subjected to different electric fields with the same field direction simultaneously. This allows the SPD to be used for displaying images. The pixels are preferably reset before an image is displayed or changed, in order to provide uniform contrast across the SPD. This is achieved by bringing the particles within the pixels into the same alignment. For example, this may involve ensuring that each pixel is in a transmissive state. This is achieved by applying appropriate voltages to at least those pixels are tuned to reflective or intermediate states in order to bring them into a transmissive state.

Where the plurality of pixels comprises cells containing separate particle suspensions and/or one or more cells divided into a plurality of regions, where one or more regions may be tuned independently of at least one other region, the SPD may be configured so that at least one of said first and second electric fields may be applied only to one or more selected particle suspensions or regions. That is, the first and/or second electric fields may be applied to particular particle suspension or region without affecting the optical properties of at least one other particle suspension or region in the SPD.

According to a fourth aspect of the invention, a method of displaying an image comprises tuning the transmittance and reflectance properties of at least one of a plurality of pixels in a suspended particle device, wherein said at least one particle suspension is tuned independently of at least one other pixel.

One of more of said pixels may be a discrete particle suspension. Alternatively, or additionally, one or more of said pixels may be a region within a compartment housing a particle suspension.

Preferably, the step of tuning comprises applying one or more electric fields to said particle suspension. The electric fields may be applied to tune the transmittance and reflectance of a particle suspension to an intermediate, or grey, value.

The step of tuning may comprise the application of a plurality of electric fields simultaneously to the particle suspension.

The step of tuning may comprise applying a plurality of electric fields in turn to the particle suspension, according to a suitable driving scheme.

The method may further comprise resetting one or more pixels within the suspended particle device by applying to a particle suspension an electric field with an orientation that is not parallel to the particle alignment.

Embodiments of the invention will now be described with reference to the accompanying drawings, in which:

FIG. 1 depicts a conventional light valve in a closed state;

FIG. 2 depicts a conventional light valve in an open state;

FIG. 3 is a graph of experimental data showing the response and relaxation times of a typical particle suspension;

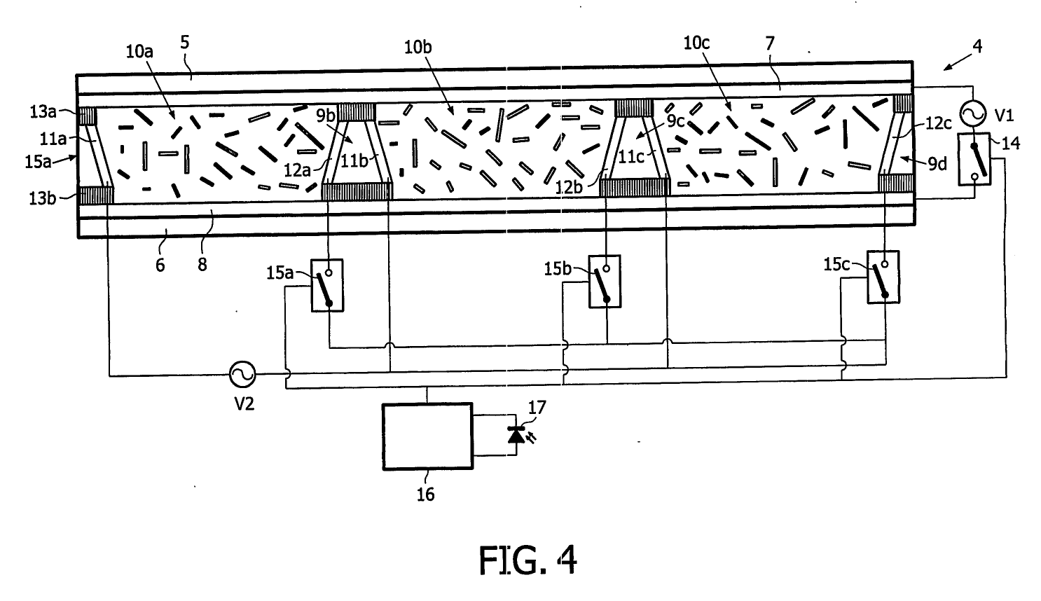

FIG. 4 is a schematic diagram of a suspended particle device according to a first embodiment of the invention in a relaxed state;

FIG. 5 depicts a portion of the suspended particle device of FIG. 3 in a transmissive state;

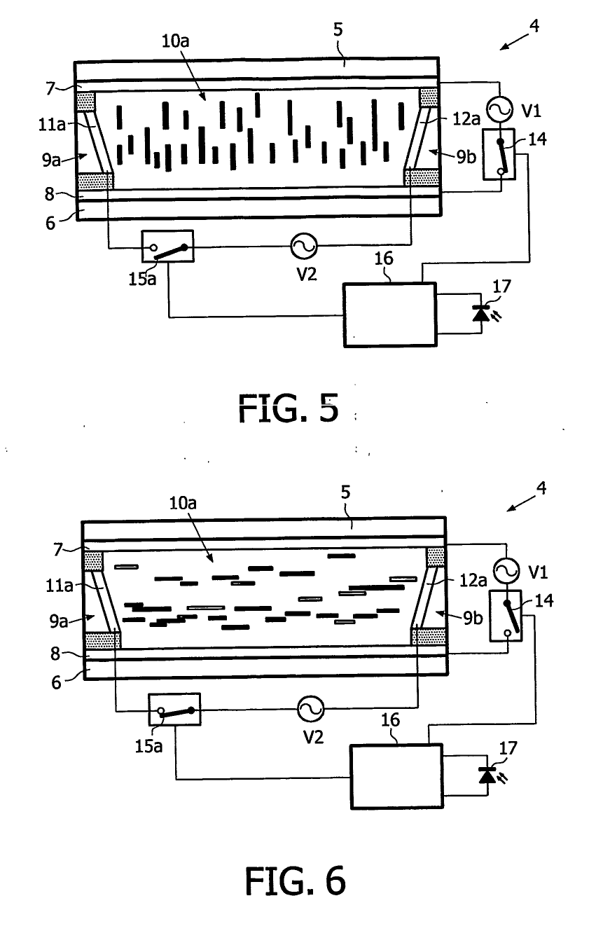

FIG. 6 shows a portion of the suspended particle device of FIG. 3 in a reflective state;

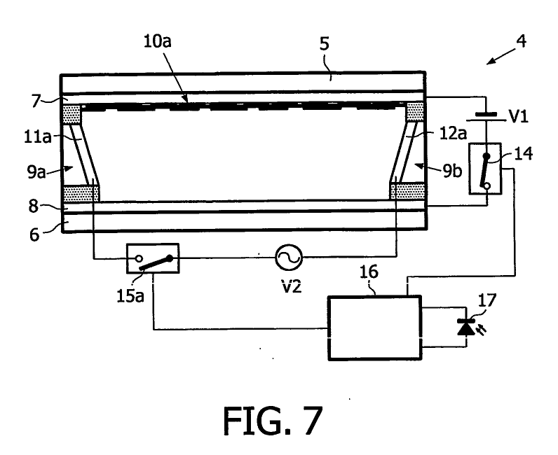

FIG. 7 shows a portion of the suspended particle device of FIG. 3 in an enhanced reflectivity state;

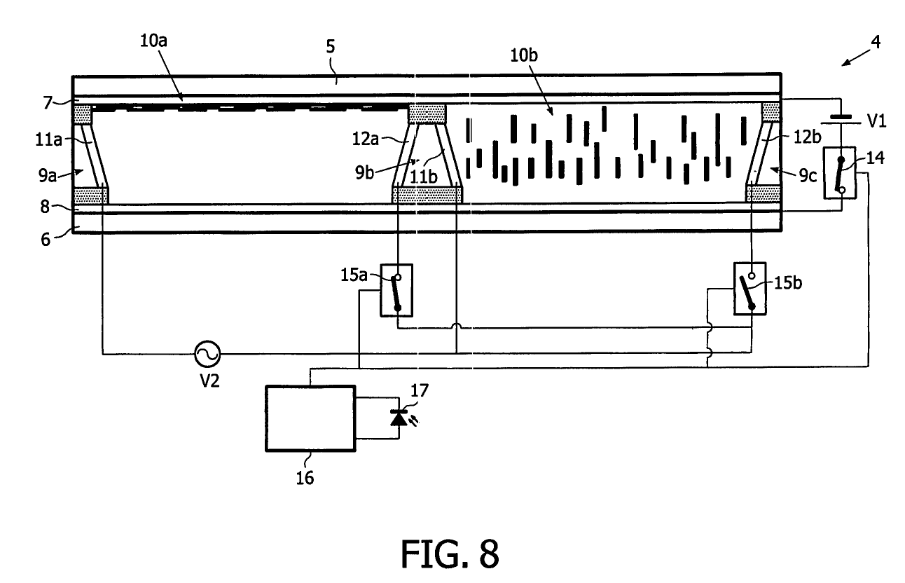

FIG. 8 shows part of suspended particle device of FIG. 3 comprising portions in different states;

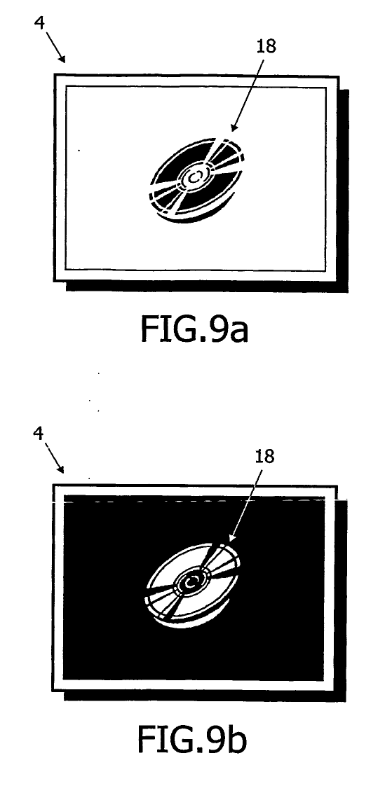

FIGS. 9a and 9b depict the display of an image using the suspended particle device of FIG. 3 in first and second display modes;

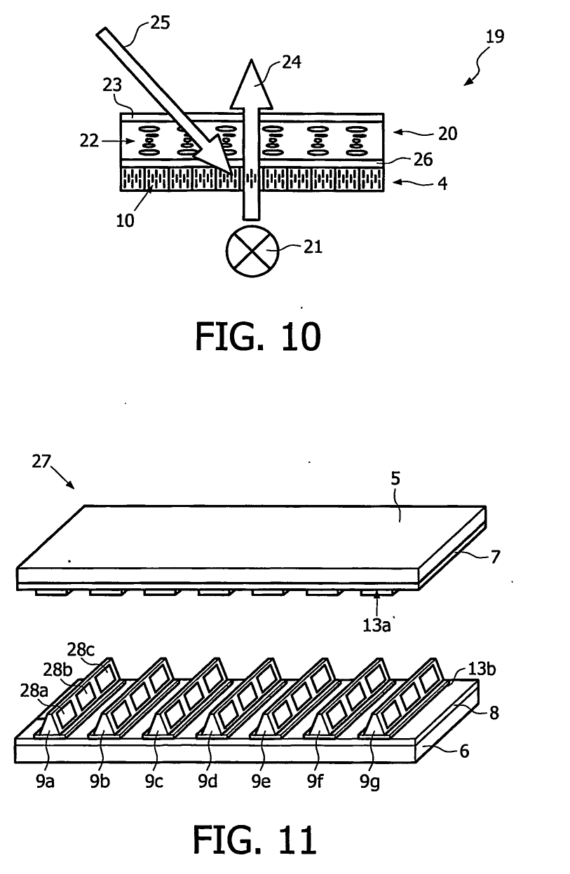

FIG. 10 is a schematic diagram of a transflective display comprising the suspended particle device of FIG. 3;

FIG. 11 is an exploded perspective view of a suspended particle device according to a second embodiment of the invention;

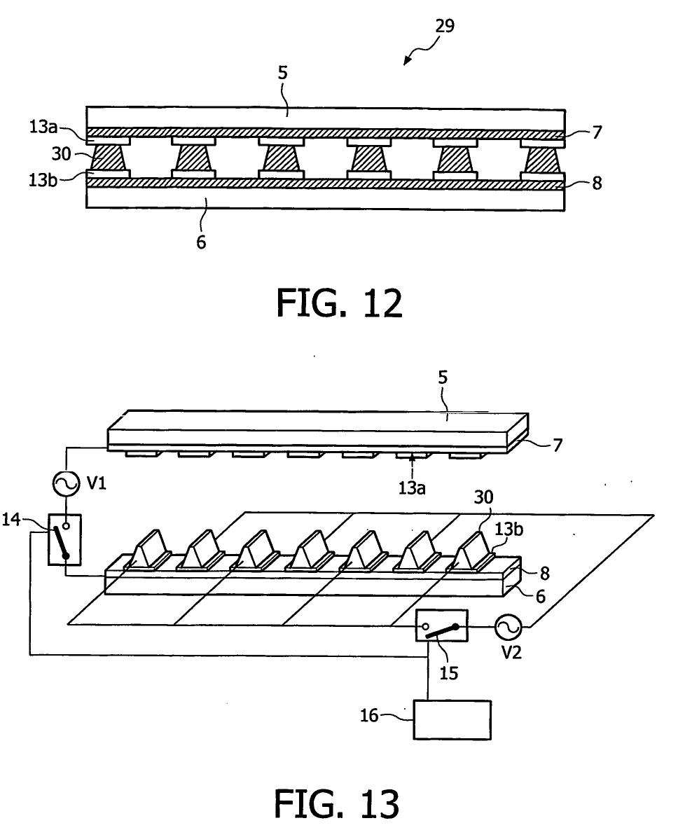

FIG. 12 is a schematic diagram of a suspended particle device according to a third embodiment of the invention;

FIG. 13 is an exploded perspective view of a row of cells in the suspended particle device of FIG. 11;

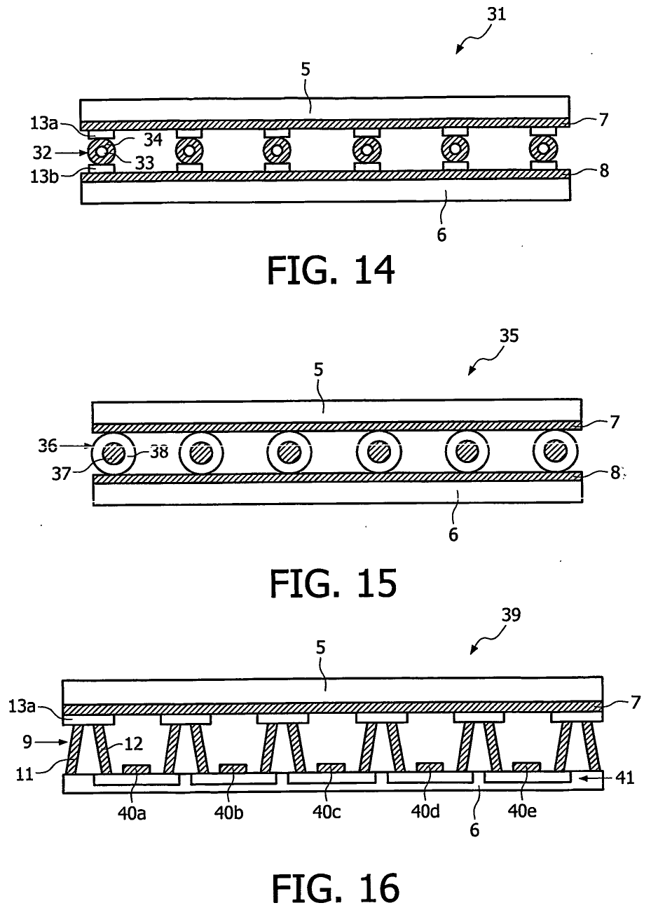

FIG. 14 is a schematic diagram of a suspended particle device according to a fourth embodiment of the invention;

FIG. 15 is a schematic diagram of a suspended particle device according to a fifth embodiment of the invention; and

FIG. 16 is a schematic diagram of a suspended particle device according to a sixth embodiment of the invention.

FIG. 4 depicts part of a SPD 4 according to a first embodiment of the present invention. The SPD 4 comprises a plate 5 and a substrate 6, which are formed from an insulating transparent material such as glass. In this example, the thicknesses of the plate 5 and substrate 6 are approximately 700 μm. Both the plate 5 and substrate 6 are coated with a layer of conducting material, such as indium tin oxide (ITO), using a process such as CVD or sputter deposition, forming electrodes 7, 8.

Spacers 9a, 9b, 9c, 9d are provided to maintain a constant gap between the plate 5 and substrate 6. The plate 5, substrate 6 and spacers 9a to 9d define a two-dimensional array of cells, each of which contains a particle suspension 10a, 10b, 10c.

The use of a number of multiple particle suspensions 10a to 10c within separate cells, rather than a single particle suspension in a relatively large cavity restricts any settling of particles to a limited volume, so that the optical properties of the remainder of the SPD 4 are unaffected. Any resulting inhomogeniety is limited to the particular cell in which the settling has occurred.

In this example, the gap between the plate 5 and substrate 6 is 200 μm and the width of the cells, that is, the interval between adjacent spacers 9a to 9d is also 200 μm. However, the SPD 4 may be configured with other gap sizes and cell widths within a range of 20 to 800 μm. In addition, it is not necessary for the gap and cell widths to correspond with one another.

Each particle suspension 10a to 10c comprises a plurality of anisometric reflective particles suspended in an insulating fluid. Examples of suitable particles include platelets of silver, aluminium or chromium, mica particles or particles of an inorganic titanium compounds. The physical dimensions of the particles are as follows. Their lengths are of the order of 1 to 50 μm and their thicknesses are within a range of 5 to 300 nm. In this particular example, the particles have a typical length of 10 μm and a thickness of 30 nm.

Examples of suitable suspension fluids include butylacetate or a liquid organosiloxane polymer with a viscosity that permits Brownian motion of the particles but prevents sedimentation.

The spacers 9a to 9d are coated with ITO layers by, for example, CVD or sputter deposition, to form electrodes 11a to 11c, 12a to 12c. The electrodes 11a to 11c, 12a to 12c on each spacer 9a to 9d are isolated from the electrodes 7, 8 on the plate 5 and substrate 6 by thin SiO₂ passivation layers 13a, 13b, in order to prevent shorting. The passivation layers 13a, 13b, are divided into portions, which are indicated in FIG. 4 using shading. The passivation layers 13a, 13b do not cover the whole area of the plate 5 and substrate 6 in order to prevent potential drops between each electrode 7, 8 and particle suspensions 10a, 10b, 10c being formed across them.

The electrodes 7, 8, 11a to 11c, 12a to 12c can be used to apply one or more electric fields to the particle suspensions 10a, 10b, 10c. Although a potential drop will exist across the passivation layer portions 13a, 13b, between each electrode 7, 8 and the spacer electrodes 11a to 11c, 12a to 12c, this is taken into account when applying voltages to the particle suspensions 10a, 10b, 10c and/or configuring driving schemes for the SPD 4.

The SPD 4 comprises circuitry for applying a first voltage V1 to electrodes 7, 8, comprising a first switch 14, and circuitry for applying a second voltage V2 to electrodes 11a to 11c, 12a to 12c, comprising second switches 15a, 15b, 15c.

In this particular example, the SPD 4 is connected to a control unit 16. If the SPD 4 is to be used in a light-responsive application, the control unit 16 may be arranged to receive data from a light sensor, such as a photodiode 17, which detects the level of ambient light in the vicinity of the SPD 4. The control unit 16 may determine desired reflectance or transmittance states for the particle suspensions 10a to 10c on the basis of the light level detected by the photodiode 17 and applies suitable voltages V1, V2 as required.

In FIG. 3, switches 14, 15a to 15c are open, so that no electric fields are applied to the particle suspensions 10a to 10c. The particles have random alignments that vary over time, due to Brownian motion. The particle suspensions 10a to 10c are semi-opaque, or opaque, depending on their respective particle concentrations. Therefore, SPD 4 will transmit only a small fraction of any incident light and reflect the remaining portion.

The SPD 4 may be switched into a transmissive state as follows. FIG. 5 shows a cell within the SPD 4 when a first voltage V1 that equals or exceeds the saturation potential of the particle suspension 10a is applied to the electrodes 7, 8 by the control unit 16. This results in a homogeneous electric field orientated so that its field lines are perpendicular to the plate 5 and substrate 6. A dipole is induced in the particles. In order to minimise the energy of the system, the particles align themselves so that they are parallel to the electric field lines as shown. This increases the transmittance of the particle suspension 10a. In this example, voltage V1 is an AC voltage, although a similar effect may be achieved by applying a DC voltage instead.

The SPD 4 can be switched into a reflective state. FIG. 5 shows one cell of the SPD 4 when a second voltage V2 that is equal to, or exceeds, the saturation potential is applied to electrodes 11a and 12a, producing a homogeneous electric field parallel to the plate 5 and substrate 6. The reflective particles align themselves so that they are parallel to the electric field, increasing the reflectance of the particle suspension 10a. A high fraction of the incident light is therefore reflected by the reflective particles. In this example, second voltage V2 is an AC voltage, although a similar effect may be achieved if V2 is a DC voltage.

The reflectance of a particle suspension 10a can be enhanced further by applying a first DC voltage V1 to electrodes 7, 8 in addition to the second voltage V2 applied to electrodes 11a, 12a simultaneously, where both the first and second voltages V1, V2 exceed the saturation potential. The second voltage V2 may be an AC or a DC voltage. This scenario is shown in FIG. 7. The reflective particles are attracted towards the plate 5 and cluster in its vicinity, giving the particle suspension 10a a particularly high reflectance. A second enhanced reflectivity state, in which the reflective particles are attracted towards the substrate 6, can be achieved in a similar manner.

In this manner, the optical properties of the particle suspension 10a can be controlled using voltages V1, V2.

As discussed above, the relaxation time associated with conventional SPDs limit their suitability for applications where rapid closure of a light valve is required. A method for overcoming this drawback will now be described. When the SPD 4 is in a transmissive state, as in FIG. 5, and switch 14 is opened, that is, when a first electric field perpendicular to the plate 5 and substrate 6 is removed, the particle alignments begin to relax into a disordered state, as shown in FIG. 4. The relaxation time may be of the order of 15 minutes, as in the example experimental data shown of FIG. 3. However, instead of allowing the particle alignment to decay in this manner, the opening of switch 14 may be followed by the closure of switch 15a, to apply a second electric field that is parallel to the plate 5 and substrate 6. The particles respond to the second electric field by aligning themselves accordingly. As the response time of the particle suspension is much shorter than its relaxation time, for example, in FIG. 3, the response time is approximately 60 s, the transmittance of the particle suspension 10a decreases relatively quickly. This results in an effective relaxation time that is considerably shorter than the time required for the particle alignments to decay through Brownian motion alone.

As it may not be necessary for the particles to be fully aligned with the second electric field to provide adequate closure of the light valve, the effective relaxation time is equal to, or less than, the response time. It is not necessary for voltage V2 to be applied for the entirety of the response time, that is, to align the particles as shown in FIG. 6. If the switch 15a is then opened, the particle alignments will gradually decay into a disordered state.

The voltages V1, V2 may be varied in order to tune the transmittance and reflectance of a particle suspension 10a to “grey” values that are intermediate to those shown in FIGS. 5 and 6, so that incident light is simultaneously transmitted and reflected by the particle suspension 10a. For example, a grey value can be achieved by applying one or more voltage V1, or V2 that is less than the relevant saturation potential, so that the particles do not align themselves completely with the field direction of the electric field.

Alternatively, a driving scheme can be used, so that the voltages V1 and V2 are applied as a series of pulses. In this case, the particle alignments continually switch between the electric field directions associated with the voltages V1, V2. The grey value achieved depends on the particle alignments in these states and the length of time during which the particle suspension 10a is in each of these states.

The cellular structure of the SPD 4 allows the transmittance and reflectance of the particle suspensions 10a to 10c to be tuned independently of one another. For example, FIG. 8 shows the SPD 4 when a first voltage V1 is applied to electrodes 7, 8, subjecting particle suspensions 10a, 10b to a first electric field. A second voltage V2 is applied to electrodes 11a, 12a, by closing switch 15a, while switch 15b is left open. This causes particle suspension 10a to be switched into a reflective state, while particle suspension 10b is in a transmissive state.

The SPD 4 can therefore be used to display an image by tuning the transmittance and reflectance of the separate particle suspensions 10a to 10c accordingly. FIG. 9a shows an example where an image 18 of a compact disc is presented by the SPD 4 by switching a number of cells into a reflective state, as indicated by solid shading. The remaining cells are switched into a transmissive state. The image 18 can be discerned by a viewer through the reflection of ambient light by the reflective cells. Alternatively, the image 18 can be displayed by switching the relevant cells into a transmissive state and the remaining cells into a reflective state, as shown in FIG. 9b.

Before an image is displayed or changed, the SPD 4 should be “reset” by bringing each particle suspension 10a, 10b, 10c into the same state. This procedure is intended to allow the image to be displayed with substantially uniform contrast across the SPD 4. For example, the display of a first image on SPD 4 may require particle suspension 10a to be in a reflective state, particle suspension 10b to be tuned to a grey value and particle suspension 10c to be in a transmissive state. The particle suspensions 10a, 10b, 10c may be reset by applying a first voltage V1, which may be AC or DC, to particle suspensions 10a, 10b, to bring them into a transmissive state. The first voltage V1 may also be applied to particle suspension 10c to maintain the alignment of its particles. This reset procedure can also be used to “clear” an image displayed by the SPD 4.

FIG. 10 depicts a display 19 in which the SPD 4 of FIGS. 3 to 8 is used as a transflector. The display 19 comprises a display device 20, which, in this example, is a liquid crystal display (LCD), and a light source 21. The LCD 20 comprises liquid crystal material 22 and a polariser 23, together with driving means, such as a matrix of column (select) and row (addressing) electrodes or a matrix of thin-film transistors, not shown. The structure and operation of such an LCD 20 are well known per se.

The SPD 4 is positioned between the LCD 20 and light source 21. When in a transmissive state, the SPD 4 allows light 24 from the light source 21 to pass through it, in order to provide backlighting for the LCD 20. When the SPD 4 is in a reflective state, the LCD 20 may be illuminated using ambient light 25 reflected by the particle suspensions, indicated generally by 10.

When the SPD 7 is switched into the reflective state shown in FIG. 6, the separation between the LCD 20 and the reflecting surface, that is the surfaces of the particles themselves, may be up to 1 mm. This reduces the resolution of the image when viewed at a wide angle. This effect can be mitigated by switching the SPD 7 into the highly reflective state, depicted in FIG. 7, when reflected illumination is required. In addition to enhancing the reflectance of the particle suspension 10, this minimises the distance between the reflecting surfaces and the LC cell 20 so that any deterioration in resolution is reduced.

The light 24 emitted by the light source 21 may have a wide angular distribution. However, the aligned particles act to collimate the light passing through the particle suspension 10, so that the resulting backlighting has a relatively narrow angular distribution. This means that a considerable fraction of the light 24 may be scattered by the particles and wasted. The efficiency of the SPD 7 in its transmissive state may be improved by using a suspension liquid with a high refractive index, so that an increased fraction of the light 24 passes through the particle suspension 10. An example of a suitable high refractive index suspension fluid is FC75. FC75 has a refractive index of 1.6, whereas the refractive index of butylacetate is 1.4.

The control unit 16 may control the particle alignments in accordance with the output from the photodiode 17. For example, in low ambient light conditions, where the light level is below a predetermined threshold, the LCD 20 is backlit by the light source 21. Where the detected ambient light level is above a predetermined threshold, the particle suspensions 10 may be switched into a reflective state, so that the LCD 20 is lit using reflected ambient light 25. In this case, the light source 21 may be switched off in order to conserve power. The control unit 16 may be configured so that, when the detected light level is within a predetermined range, the transmittance and reflectance of the particle suspensions 10 may be tuned to a grey value, so that the LCD 20 is illuminated using a combination of transmitted and reflected light 24, 25. If required, the display 19 may be configured to adjust the output of the light source 21 accordingly.

The display 19 may further comprise a quarter-wave plate 26, in order to ensure that any transmitted light 24 and/or reflected ambient light 25 is of the appropriate polarisation for transmission through the polariser 23.

The display 19 is configured so that, in a normal operation mode, images are displayed by the LCD 20. When the transflective display is in a standby mode, relatively low resolution images are displayed using the SPD 4, using the method described above with reference to FIGS. 9a and 9b.

FIG. 11 depicts a SPD 27 according to a second embodiment of the invention. In this embodiment, spacers 9a to 9g are provided with a plurality of electrodes. For example, spacer 9a is provided with three electrodes 28a, 28b, 28c, while corresponding electrodes are provided on spacer 9b, which are hidden from view in FIG. 11. A compartment defined by the plate 5, substrate 6 and spacers 9a, 9b is effectively subdivided into a plurality of regions that can be subjected to different electric fields using the pairs of electrodes 28a, 28b, 28c provided on spacers 9a, 9b. In other words, a particle suspension, not shown, within the compartment may be subjected to an inhomogeneous electric field with a field direction that is parallel to the plate 5 and substrate 6.

The electrodes 7, 8 may be divided similarly, so that a region of a particle suspension housed within the compartment may be tuned to a given transmittance or reflectance value completely independently of one or more other regions within the same compartment.

An active matrix (not shown) may be used to address the electrodes 28a, 28b, 28c etc. and, where provided, multiple electrodes located on the plate 5 and substrate 6, to facilitate tuning of the individual regions.

The SPDs 4, 27 of FIGS. 3 and 11 comprise spacers 9a to 9d in the form of ribs, covered with conducting material 11a to 11c, 12a to 12c, 28a to 28c. However, the invention is not limited to SPDs comprising this particular form of spacer. Examples of SPDs with other suitable spacers are shown in FIGS. 12 to 16. In these figures, the particle suspensions 10, 10a to 10c, switches 14, 15a to 15c, control unit 16, optional light sensor 17 and electrical connections are not shown, while conductive material, such as the electrodes 7, 8 and electrodes provided in, on or by the spacers, are indicated using shading.

In a third embodiment of the invention, shown in FIG. 12, a SPD 29 comprises spacers in the form of conductive ribs 30. Suitable materials for forming the conductive ribs include conducting polymer material or metals such as copper, nickel or aluminium. As in the first embodiment, thin SiO₂ passivation layers 13a, 13b are provided to prevent short-circuits between the ribs 30 and electrodes 7, 8.

Each rib 30 forms a single electrode and so cannot be connected to the sources of voltage V2 in the same manner as the electrodes 11a to 11c, 12a to 12c, in the SPD 4 of FIG. 3. FIG. 13 is an exploded view of one row of cells within the SPD 29 of FIG. 12. As in the first embodiment, electrodes 7, 8 are connected to a source providing a first voltage V1. The SPD 29 is arranged so that adjacent ribs 30 are connected to opposite terminals of a source of the second voltage V2. That is, where one rib is connected to the positive terminal, its adjacent rib or ribs will be connected to the negative terminal, and vice versa. Therefore, when a DC second voltage V2 is applied to the SPD 27, the direction of the electric field will vary between two opposing directions from cell to cell. However, as the optical properties of the particle suspensions 10a to 10c depend on the alignment of the particle and not its specific orientation, this does not affect the resulting reflectance of a cell.

In the particular arrangement shown in FIG. 13, the cells are not addressable individually, the second voltage V2 being applied to all ribs 30 when switch 15 is closed. However it is possible to modify the SPD 29, by including further switches, so that the second voltage V2 is applied to selected pairs or groups of ribs 30. The second voltage V2 may also be applied to selected ribs 30 sequentially, if required.

FIG. 14 shows a SPD 31 according to a fourth embodiment of the invention, in which the spacers 32 comprise an insulating core 33 covered with a conductive layer 34. In this example, the spacers 32 are formed by coating a glass fibre core with ITO using a CVD or sputtering process. In a similar manner to the previous embodiments, the conductive layers 34 are isolated from electrodes 7, 8 by thin SiO₂ passivation layers 13a, 13b. The conductive layers 34 are connected to a source of voltage V2 using a scheme similar to that depicted in FIG. 13 in relation to the third embodiment.

In a SPD 35 according to a fifth embodiment of the invention, shown in FIG. 15, the spacers 36 are formed by electrodes, which, in this example, are metallic wires 37. The electrodes 37 are coated with insulating material 38, such as Si₃N₄ or SiO₂. The insulating material 38 acts to isolate electrodes 37 from the electrodes 7, 8 on the plate 5 and substrate 6 and so the thin SiO₂ passivation layers included in the previous embodiments are not required. The electrodes 37 are connected to a source of voltage V2 using a scheme similar to that described in relation to the third embodiment.

FIG. 16 shows a SPD 39 according to a sixth embodiment of the invention, that includes spacers 9 carrying electrodes 11, 12 similar to the spacers 9a to 9d and electrodes 11a to 11c, 12a to 12c in the SPD 7 of FIG. 3. The SPD 39 differs from those previously described in that the electrode carried by the substrate 6 is divided into individual portions 40a, 40b, 40c, 40d, 40e, forming a pixellated array corresponding to the cells of the SPD 39. The electrodes 40a to 40e are addressable and can be individually activated using an active matrix arrangement 41. This allows the first voltage V1 to be applied to one or more selected cells independently of the remaining cells in the SPD 39.

This embodiment facilitates the use of grey values in imaging. In the first embodiment, cells were tuned individually by applying a first voltage V1 to all cells and selectively applying a second voltage V2. This meant that cells were either in a transmissive state or in an enhanced reflectivity state, as shown in FIG. 8. However, in SPD 39, as the first voltage V1 can be applied selectively, cells can be tuned to intermediate values independently, by using appropriate values for voltages V1, V2 and/or employing a suitable timing scheme.

The active matrix arrangement 41 can also be used to address and apply voltage V2 to selected electrodes 11, 12 on the spacers 9.

In this particular embodiment, the pixellated electrodes 40a to 40e are configured so that they are isolated from the electrodes 11, 12 on the spacers 9. Therefore, it is no need for a thin SiO₂ passivation layer on the substrate 6.

The use of an active matrix arrangement 41 is not limited to the type of spacer 9 shown in FIG. 16. Any suitable form of spacer can be used, including those shown in the first to fifth embodiments.

From reading the present disclosure, other variations and modifications will be apparent to persons skilled in the art. Such variations and modifications may involve equivalent and other features which are already known in the design, manufacture and use of suspended particle devices, transflective displays and component parts thereof and which may be used instead of or in addition to features already described herein.

The particle suspensions 10, 10a to 10c, plate 5, substrate 6 and electrodes 7, 8, 11a to 11e, 12a to 12e, 38, 40a to 40e, ribs 30, conductive layers 34, insulating layers 13a, 13b, 36 and insulating cores 33 may be provided using suitable materials other than those mentioned above. For example, the plate 5 may be formed using transparent plastic material instead of glass. The substrate 6 may also be formed from glass or plastic and may, if required, also be transparent. Some or all of the electrodes 7, 8, 11, 11a to 11e, 12, 12a to 12e, 37, 40a to 40e, ribs 30 and conductive layers 34 may be formed using a transparent electrically conductive film of material other than ITO, such as tin oxide (SnO₂). Other suitable materials for the electrodes 11, 11a to 11e, 12, 12a to 12e and conductive layers 32 include conducting polymer, silver paste and metals such as copper, nickel, aluminium etc., deposited onto the spacers 9 by electroplating or printing.

Additional insulator layers may be included in a SPD 4, 27, 29, 31, 39 without departing from the scope of the invention. For example, in the SPD 4 of the first embodiment, a transparent layer of insulating material, such as SiO2, may be provided, covering each of the ITO layers 7, 8, separating said layers 7, 8 from the particle suspensions 10a, 10b, 10c. Potential drops between the electrodes 7, 8 and the spacer electrodes 11a to 11c, 12a to 12c are then avoided. Although this arrangement results in potential differences between the electrodes 7, 8 and the particle suspensions 10a, 10b, 10c, these may be compensated by selecting appropriate values for the first voltage V1 and can be taken into account when devising driving schemes for the SPD 4.

Similar additional insulating layers may be included in the SPDs 27, 29, 31, 39 of the second, third, fourth and sixth embodiments, if required. The reset procedure described in relation to the first embodiment can be applied to any SPD comprising means for applying more than one electric field. It is not necessary for the SPD to contain multiple cells. For example, the procedure can be used in a SPD with a single particle suspension 10, where means for applying voltages V1 and V2 are included. The procedure could also be used in a SPD where electrodes project into a compartment housing a particle suspension at intervals without dividing the SPD into discrete cells.

In addition, while the SPDs 4, 27, 29, 31, 35, 39 according to the described embodiments each comprise an array of identical cells or regions, the shapes and sizes of the cells and/or regions may vary within the SPD 4, 27, 29, 31, 35, 39. For example, if the SPD 4, 27, 29, 31, 35, 39 is intended to display a particular image, such as a set of icons or a logo, the shapes and sizes of the cells or regions may be configured accordingly, in order to minimise the number of switches 14, 15, 15a to 15c in the SPD 4, 27, 29, 31, 35, 39 and to simplify its control and operation.

The SPD 4, 27, 29, 31, 35, 39 may be configured so that a second voltage V2 can be applied to a group of cells or regions using a single switch 20 in order to display a predetermined image.

The SPD 4, 27, 29, 31, 35, 39 may be configured to maintain its optical properties and/or a displayed image 18 by applying constant or intermittent electric fields to particle suspensions 10a to 10c. An image 18 may also be displayed on the SPD 4 and simply allowed to decay over the relaxation time, without “refreshing” or maintaining particle alignments.

It is not necessary for the display 19 to comprise an LCD 20. The invention may be implemented using other types of display device, such as micro-mechanical (MEMS) displays, electrowetting, electrochromic or electrophoretic devices.

It is not essential for the SPD 4, 27, 29, 31, 35, 39 to include a light sensor 17. If the SPD is not used in a light responsive application, for example, if the SPD is used as a display device or a shutter that responds to conditions other than light levels, the provision of a light sensor 17 is unnecessary.

Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. A suspended particle device (4, 27, 29, 31, 35, 39) comprising:
at least one compartment for housing a particle suspension (10, 10a, 10b, 10c);
means for applying a first electric field to the particle suspension (10, 10a, 10b, 10c), configured so that the first electric field has a first orientation; and
means for applying a second electric field to the particle suspension (10, 10a, 10b, 10c), configured so that the second electric field has a second orientation that is different from said first orientation.

2. A suspended particle device (4, 27, 29, 31, 35, 39) according to claim 1, wherein said first and second orientations are mutually perpendicular.

3. A suspended particle device (4, 27, 29, 31, 35, 39) according to claim 1, comprising a plurality of spacers (9, 30, 32, 36) for defining a plurality of compartments.

4. A suspended particle device (29) according to claim 3, wherein said means for applying a second electric field to the particle suspension are provided by said spacers (30).

5. A suspended particle device (35) according to claim 3, wherein said means for applying a second electric field to the particle suspension are provided within said spacers (36).

6. A suspended particle device (4, 27, 31) according to claim 3, wherein said means for applying a second electric field to the particle suspension (10, 10a, 10b, 10c) are located on said spacers (9, 30).

7. A suspended particle device (27) according to claim 6, wherein said means for applying a second electric field are arranged to apply an inhomogeneous electric field to the particle suspension (10, 10a, 10b, 10c)

8. A suspended particle device (4, 27, 29, 31, 35, 39) according to claim 1 and comprising a plurality of compartments, configured so that one or more electric fields may be applied to a selected particle suspension (10a, 10b, 10c) independently of at least one other particle suspension (10a, 10b, 10c).

9. A suspended particle device (27, 39) according to claim 7, further comprising an active matrix (41).

10. A suspended particle device (4, 27, 29, 31, 35, 39) according to claim 1, configured to apply first and second electric fields simultaneously to one or more particle suspensions (10, 10a, 10b, 10c).

11. A suspended particle device (4, 27, 29, 31, 35, 39) according to claim 1, configured so that transmittance and reflectance properties of one or more particle suspensions (10, 10a, 10b, 10c) can be tuned to a grey value.

12. A suspended particle device (4, 27, 29, 31, 35, 39) according to claim 10, configured to apply first and second electric fields in turn to one or more particle suspensions (10, 10a, 10b, 10c) according to a driving scheme.

13. A suspended particle device (4, 27, 29, 31, 35, 39) according to claim 1, wherein at least one of said first and second electric fields is an AC field.

14. A suspended particle device (4, 27, 29, 31, 35, 39) according to claim 1, wherein at least one of said first and second electric fields is a DC field.

15. A suspended particle device (4, 27, 29, 31, 35, 39) according to claim 1, wherein at least one of said first and second electric fields is a homogeneous electric field.

16. A suspended particle device (4, 27, 29, 31, 35, 39) according to claim 1, wherein at least one of said first and second electric fields is an inhomogeneous electric field.

17. A suspended particle device (4, 27, 29, 31, 35, 39) comprising:
a transparent plate (5);
a substrate (6); and
a plurality of spacers (9, 30, 32, 36);
wherein said spacers (9, 30, 32, 36) define a plurality of pixels.

18. A suspended particle device (4, 27, 29, 31, 35, 39) according to claim 17, wherein one or more of said pixels are compartments defined by the transparent plate (5), substrate (6) and spacers (9), said compartments being arranged to house a particle suspension (10a, 10b, 10c).

19. A suspended particle device (4, 27, 29, 31, 35, 39) according to claim 17, wherein said plurality of spacers (9, 30, 32, 36) comprise means for applying an electric field to a compartment.

20. A suspended particle device (4, 27, 29, 31, 35, 39) according to claim 19, wherein one or more of said pixels are defined by regions within a compartment arranged to house a particle suspension (10a, 10b, 10c) and said spacers (9) comprise means for simultaneously applying a first electric field with a given field direction to a first region and a second electric field with the same field direction to at least one other region.

21. A suspended particle device (33) according to claim 19, wherein the means for applying an electric field are located within the spacers (36).

22. A suspended particle device (27) according to claim 19, wherein the means for applying an electric field are provided by the spacers (30).

23. A suspended particle device (4, 27, 31) according to claim 19, wherein the means for applying an electric field are located on the spacers (9, 32).

24. A suspended particle device (4, 27, 29, 31, 35, 39) according to claim 17, wherein one or more electric fields may be applied to a selected pixel (10a, 10b, 10c) independently of at least one other pixel (10a, 10b, 10c).

25. A suspended particle device (27, 39) according to claim 20, further comprising an active matrix (41) for addressing the pixels.

26. A suspended particle device (4, 27, 29, 31, 35, 39) according to claim 17, configured to apply first and second electric fields simultaneously to one or more pixels (10a, 10b, 10c).

27. A suspended particle device (4, 27, 29, 31, 35, 39) according to claim 17, configured so transmittance and reflectance properties of a pixel (10a, 10b, 10c) can be tuned to a grey value.

28. A suspended particle device (4, 27, 29, 31, 35, 39) according to claim 27, configured to apply first and second electric fields to one or more pixels (10, 10a, 10b, 10c) according to a driving scheme.

29. A transflector comprising a suspended particle device (4, 27, 29, 31, 35, 39) according to claim 1.

30. A transflective display (19) comprising:
a display device (20); and
a transflector according to claim 29.

31. A method of operating a suspended particle device (4, 27, 29, 31, 35, 39) including a particle suspension (10, 10a, 10b, 10c), comprising the steps of:
applying to the particle suspension (10, 10a, 10b, 10c) a first electric field with a first field direction to control alignment of particles therein; and
resetting the suspended particle device (7, 27, 29, 33, 37) by applying to the particle suspension (10, 10a, 10b, 10c) a second electric field with a second field direction that is different from the first field direction.

32. A method according to claim 31, wherein the suspended particle device (4, 27, 29, 31, 35, 39) comprises a plurality of pixels in the form of separate particle suspensions and at least one of said first and second electric fields are applied only to one or more selected particle suspensions.

33. A method according to claim 31, wherein the suspended particle device (4, 27, 29, 31, 35, 39) comprises a plurality of pixels in the form of regions of a particle suspension (10, 10a, 10b, 10c).

34. A method of displaying an image comprising:
tuning the transmittance and reflectance properties of at least one of a plurality of pixels in a suspended particle device (7, 27, 29, 33, 37), wherein said at least one pixel is tuned independently of at least one other pixel.

35. A method according to claim 34, wherein one or more of said plurality of pixels are discrete particle suspensions (10a, 10b, 10c).

36. A method according to claim 34, wherein one or more of said plurality of pixels are regions within a compartment housing a particle suspension (10, 10a, 10b, 10c).

37. A method according to claim 35, wherein said step of tuning comprises:
applying one or more electric fields to one or more pixels.

38. A method according to claim 37, wherein a plurality of electric fields are applied simultaneously to the pixel.

39. A method according to claim 37, wherein a plurality of electric fields are applied to the pixel in turn, according to a driving scheme.

40. A method according to claim 34, further comprising:
resetting the suspended particle device (4, 27, 29, 31, 35, 39) by tuning at least one pixel, so that the transmittance and reflectance properties of the pixels are constant across the suspended particle device (4, 27, 29, 31, 35, 39).
